(19) United States
(12) Patent Application Publication
(10) Pub. No.: US 2008/0199594 A1
(43) Pub. Date: Aug. 21, 2008

(54) METHOD OF ENHANCING A FOOD PRODUCT AND AN IMPROVED FOOD PRODUCT

(76) Inventor: Paul EISENHAUER, Waukesha, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/032,786

(22) Filed: Feb. 18, 2008

Related U.S. Application Data
(60) Provisional application No. 60/890,677, filed on Feb. 20, 2007.

(51) Int. Cl. A23L 1/317; A23L 1/00

(52) U.S. Cl. 426/646; 426/523; 426/509

(57) ABSTRACT

A method for enhancing a food product is provided. The enhanced food product is a bratwurst sausage product and the method comprises the steps of cooking the bratwurst sausage product, soaking the cooked bratwurst sausage product in a liquid bath, bringing the liquid of the liquid bath and the bratwurst sausage product contained in the liquid bath to a non-boiling simmer, cooling the liquid of the liquid bath and the bratwurst sausage product contained in the liquid bath, removing the bratwurst sausage product from the liquid bath, and alternatively re-heating the bratwurst sausage product for immediate consumption or freezing the bratwurst sausage product for later consumption.

This application claims the benefit and priority of U.S. Provisional Patent Application No. 60/890,677 filed Feb. 20, 2007.

### FIELD OF THE INVENTION

This invention relates generally to food products and methods for enhancing food products. More particularly, it relates to a method for enhancing the flavor, juiciness and mouth-feel of a meat sausage product.

### BACKGROUND OF THE INVENTION

Meat products of all types are consumed in substantial quantities on a daily basis. Such meat products include meat sausage products, one of which is the “bratwurst,” a German sausage that has been produced and consumed since approximately 1400 AD. The name “bratwurst” originates from the Old High German phrase “brätwurst.” Broken down into its component parts, the word “bratwurst” means “fine chopped meat” (i.e. “brat-”), which is usually comprised of pork, beef and veal, and “sausage” (i.e. “-wurst”). The word “brät” can also be construed to describe the way this delectable sausage is most frequently prepared in its native German-speaking parts of the world, which is by pan frying or roasting (i.e. from the German verb “bräten”). While the bratwurst can be cooked in conventional German fashion, it can also be conveniently and flavorfully grilled.

In the United States, the bratwurst, which is also affectionately and simply referred to as the “brat,” tends to be a regional food product, consumed primarily in areas of this country where Germanic immigrants and their ancestors settled. Wisconsin is one such part of the country. For example, the city of Milwaukee, Wis., is home to several well-known sausage-making companies that produce the bratwurst for consumption in Wisconsin and elsewhere. However, the city of Sheboygan, Wis., which has a number of well-known local sausage-making companies of its own, holds the distinction of being heralded as the “Bratwurst Capital of America.” Each summer, Sheboygan celebrates a regional festival known as “Sheboygan Bratwurst Days.” This festival even features a bratwurst-eating contest that draws contestants from around the globe.

Indeed, the bratwurst has become a necessity for the complete enjoyment of many outdoor events including tailgate parties at the ballpark or other sporting event, institutional picnics and family barbecues. There are many varieties of uncooked and cooked bratwurst products on the market made by many sausage producers. Among those mentioned earlier, Wisconsin is host to one bratwurst producer in particular that produces a very fine and tasteful original bratwurst product. It is also one of the largest producers of bratwurst in the country. That sausage-maker is Johnsonville Sausage, LLC of Kohler, Wis. As good as this sausage-maker's bratwurst product is, this inventor has devised a method for improving the taste of the final cooked bratwurst product. While this inventor's method has particular application to that product, it is to be understood that the method disclosed in the present application is not limited to bratwurst products made by this producer and that the bratwurst products of other sausage-makers could be improved by the method presented herein.

In the view of this inventor, there has been, and there continues to be, a need for a new and non-obvious method for improving the taste of a bratwurst sausage product.

### SUMMARY OF THE INVENTION

It is, therefore, a principal object of this invention to provide a new, useful, and non-obvious method for improving the taste of a bratwurst product. It is another object to provide such a method such that a minimal number of steps and equipment is required to implement the method. It is yet another object of the present invention to provide such a method whereby the taste of a bratwurst product can be improved by using foodstuffs that are readily and commercially available to the consumer. It is still another object of the present invention to provide such a method whereby the improved bratwurst product can be stored frozen and re-heated for convenient consumption by the consumer.

The present invention has obtained these objects. In a first preferred embodiment, it provides for a method that carefully controls the initial grilling process of the bratwurst product. Once grilled, the bratwurst product is allowed to soak sully submerged within a liquid bath, the liquid and bratwurst product being brought to a non-boiling simmer for a pre-determined period of time. Following this period of time, the liquid and the bratwurst product are then cooled in a refrigeration unit for another pre-determined period of time. Following this cooling period, the final bratwurst product can then be re-heated for immediate consumption or frozen for later consumption by the consumer.

The foregoing and other features of the method that is used in accordance with the present invention will be apparent from the detailed description that follows.

### BRIEF DESCRIPTION OF THE DRAWINGS

FIG. 1 is a top plan view of a first bratwurst grilling position in accordance with the method of the present invention.

FIG. 2 is a top plan view of a second bratwurst grilling position in accordance with the method of the present invention

FIG. 3 is a top plan view of a third bratwurst grilling position in accordance with the method of the present invention

FIG. 4 is a right side elevational view of the third bratwurst grilling position illustrated in FIG. 3 and taken along line 4-4 of FIG. 3.

FIG. 5 is a top plan view of a fourth bratwurst grilling position in accordance with the method of the present invention.

FIG. 6 is a right side elevational view of the fourth bratwurst grilling position illustrated in FIG. 5 and taken along line 6-6 of FIG. 4.

FIG. 7 is a front elevational and cross-sectioned view of a cooking container illustrating bratwurst held within the container as liquids are added to the container.

FIG. 8 is the same view of the container shown in FIG. 7 and illustrating bratwurst completely submerged within the liquids that have been added to the container.

FIG. 9 is the same view of the container shown in FIG. 8 and illustrating the container and contents being heated.

FIG. 10 is a similar view of the container as is shown in FIG. 9 and illustrating the heated container and contents being placed within a cooler, such as a refrigerator unit.

FIG. 11 is another view of the container shown in FIG. 7 and illustrating the previously submerged bratwurst having absorbed some of the liquids that had been added to the container.

FIG. 12 is another view of the container shown in FIG. 11 and illustrating that the container and its contents are re-heated for consumption.

### DETAILED DESCRIPTION

Referring now to the drawings in detail, wherein like numbered elements refer to like elements throughout, FIGS. 1 through 6 illustrate the preferred sequential cooking positions of the bratwurst sausage product in accordance with the present invention. While no specific type of grill unit is shown, it is to be understood that any variety of charcoal or gas-fueled grill unit could be used in the method of the present invention. However, this inventor prefers to use a charcoal grill for the method disclosed. Charcoal grills use charcoal briquettes as the fuel source. The briquettes, when lit, transform themselves into burning embers that produce the heat that is necessary for cooking meat and other products on the grill. The burning briquettes are typically retained within some sort of pan-like structure, which is supported by legs, and above which is placed a cooking grid. The cooking grid is that structure upon which the food product to be cooked, or “grilled,” is placed. Gas-fueled grills use natural gas or propane as the fuel source. Since the particular type of grill is not a limitation of the present invention, the figures shown will illustrate a cooking grid that is suspended above a heat source.

Referring first to FIG. 1, it shows a cooking grid, generally identified 10, of a conventional grill unit (not shown). The grid 10 includes a plurality of longitudinally-extending and equally-spaced, parallel rods 12, the grid 10 and rods 12 being supported above a heat source 20. See FIG. 4. As shown in FIG. 1, a plurality of bratwurst sausages, or “brats” as they will be referred to herein and generally identified 1, are placed on their side on the grid 10 and rods 12. As shown, each brat 1 is typically a slightly C-shaped, arcuate sausage, each having a generally C-shaped central axis. Although shown as being spaced apart, the brats 1 are, in the preferred embodiment of the present invention, placed more closely together. This ensures that only one side of the brat 1 is exposed to the heat source 20 at one time. This also allows a more efficient and complete usage of the complete cooking grid 10. In the preferred embodiment of the method of the present invention, approximately twenty-two brats 1 will be placed on the cooking grid.

When placed in this “first cooking position,” this inventor will allow the brats 1 to remain in this position for about 8 to 10 minutes, depending upon the thermal intensity of the heat source 20.

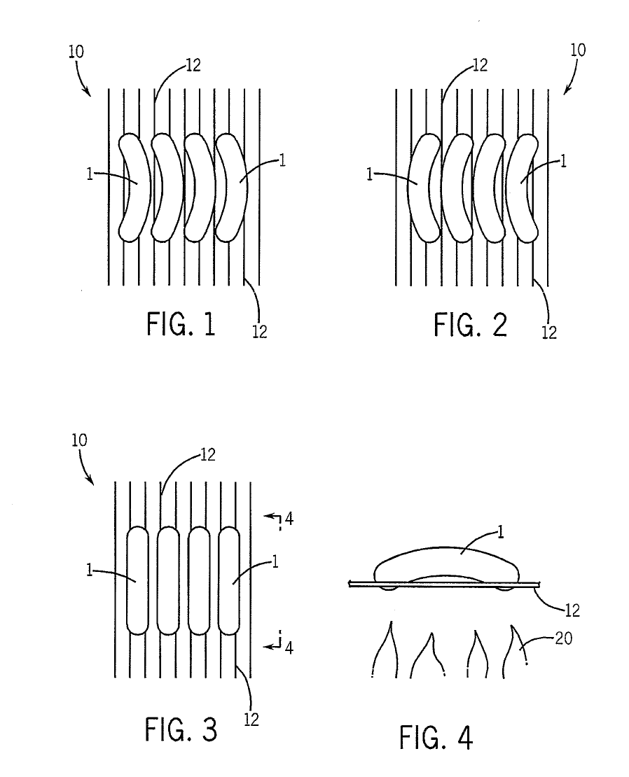

Once this cooking time has elapsed, the brats 1 are rotated axially 180° to the “second cooking position” as is shown in FIG. 2. Again, the brats 1 are allowed to remain in this position for another 8 to 10 minutes.

Once this cooking time has elapsed, the brats 1 are next rotated axially 90° to the “third cooking position” as is shown in FIGS. 3 and 4. In this position, the generally C-shaped brats 1 face downwardly. Again, the brats 1 are allowed to remain in this position for another 8 to 10 minutes.

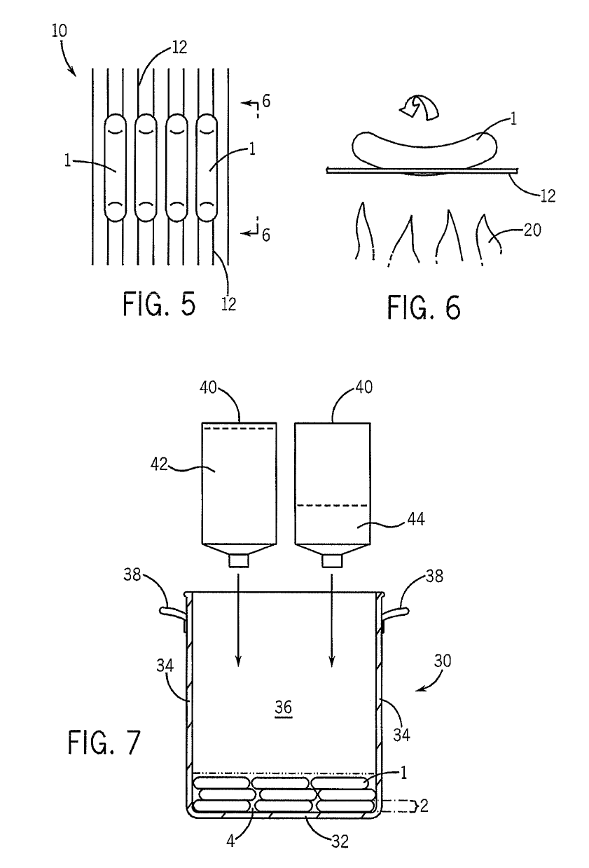

Once this cooking time has elapsed, the brats 1 are again rotated axially 180° to the “fourth cooking position” as is shown in FIGS. 5 and 6. In this position, the generally C-shaped brats 1 face upwardly. Again, the brats 1 are allowed to remain in this position for another 8 to 10 minutes. At this point, the brats 1 are fully cooked and ready to be removed from the grill grid 10.

Upon removal of the brats 1 from the heat source 20, the brats 1 are placed into a large cooking pot 30. See FIG. 7. The cooking pot 30 is typically a metal structure that includes a floor 32 and integrally-formed, continuous sidewall 34. The floor 32 and sidewall 34 define a cooking chamber 36. Handles 38 are provided to assist the user in moving the cooking pot 30 and its contents from one location to another. While the cooking pot 30 is illustrated as a cylindrically-shaped structure, it is to be understood that the shape of the cooking pot 30 is not a limitation of the present invention. Although the cooking pot 30 used by this inventor is preferably a stainless steel construction, such is not a limitation of the present invention.

As shown in FIG. 7, the freshly cooked brats 1 are layered 2, still warm, into the cooking chamber 36 of the pot 30. This is done by effectively “packing” the brats 1 into the cooking chamber 36 such that there is an absolute minimum of space 4 between adjacent brats 1. This insures that the brats 1 will remain submerged beneath the liquid that is soon to be added to the cooking chamber 36 and that a minimum amount of liquid will be required for the next step in the method of the present invention. Here again, this inventor is able to pack approximately twenty-two brats 1 per layer 2.

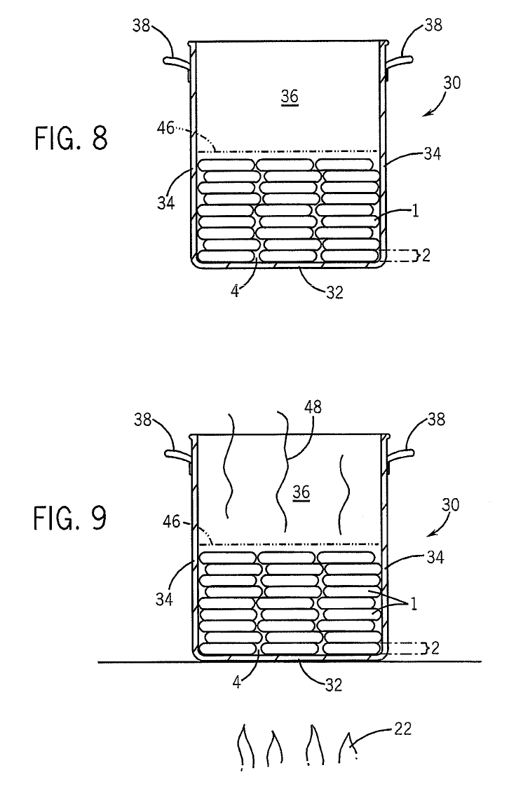

Once several layers 2 of brats 1 (preferably three layers, in the experience of this inventor, as this is optimal) have been packed into the chamber 36, two liquids 42, 44 in two different quantities are added. The first liquid 42 that is added is contained within a pre-packaged, liquid container 40. In the preferred embodiment, the first liquid 42 is Miller® Genuine Draft beer (Miller® is a registered mark of Miller Products Company, Milwaukee, Wis.). The container 40 is a twelve-ounce can of the first liquid 42. This inventor empties the full container 40 of the first liquid 42 into the chamber 36. The second liquid 44 is bottled water and this inventor adds enough of the second liquid 44 to fill one-third of the original container 40 that the first liquid 42 came in. This effectively produces a three-to-one ratio of the first liquid 42 to the second liquid 44. In the preferred embodiment, three additional layers 2 of brats 1 are then placed atop the previous layers 2 and additional liquid 42, 44 is added in the same proportion. This step is repeated until all brats 1 have been placed into the chamber 36. See FIG. 8. At this point, the overall liquid level 46 should be approximately one inch above the last layer 2 of brats 1. If more liquid 42, 44 is required, it should be added in the same three-to-one proportion mentioned above. It should also be mentioned that all layers 2 of brats 1 could first be added to the cooking pot chamber 36 and then all of the liquid 42, 44 could be added at one time without deviating from the scope of the present invention.

Once all of the brats 1 and liquid 42, 44 have been added, the cooking pot 30 and its contents is placed over a second heat source 22. This second heat source 22 is relatively low and should be applied for a sufficient time to raise the temperature of the liquid 42, 44 and brats 1 to a point that, at ambient room temperature, steam 48 can be seen emanating from the cooking pot 30, but not to the point that the liquid 42, 44 ever boils. This typically takes several hours. See FIG. 9. The point here is that, while the temperature of the liquid 42, 44 needs to be elevated, it cannot be elevated to the point that any substantial amount of the liquid 42, 44 is boiled off or released as liquid vapor.

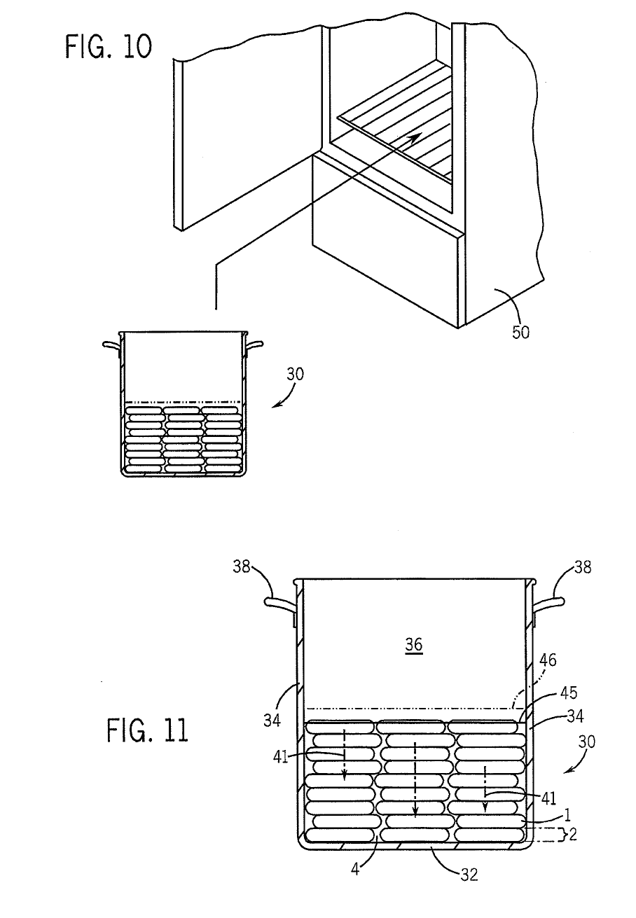

Once several hours have passed, the cooking pot 30 and its contents is removed from the secondary heat source 22 and placed into a refrigeration unit 50. There, the cooking pot 30 and its contents remain for approximately twelve hours. See FIG. 10. Once this amount of time has passed, the cooled cooking pot 30 and its contents is removed from the refrigeration unit 50. Upon removal of the cooking pot 30 and its contents from the refrigeration unit 50, it will be seen that the overall liquid level 46 of the combined liquids 42, 44 will have dropped to a lower level 45 due to the absorption of the combined liquids 42, 44 into the then-enhanced and improved brats 1. See FIG. 1 1.

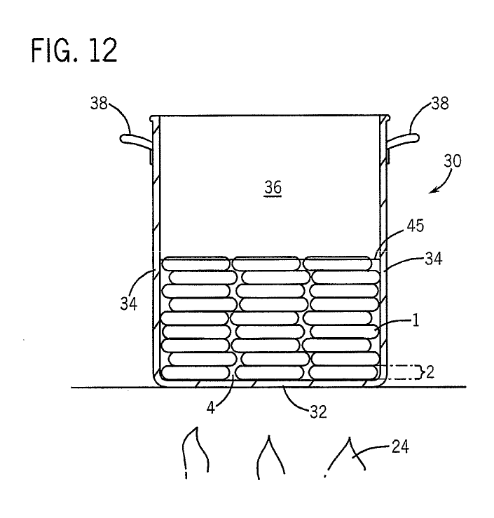

At this point, the improved brats 1 can be re-heated by a third heat source 24 for consumption. See FIG. 12. Alternatively, the improved brats 1 may be frozen, with or without any of the residual liquid 42, 44, for re-heating at a later time. Regardless of whether the brats 1 are re-heated immediately upon the conclusion of the method disclosed herein, or are re-heated following freezing, the improved brats 1 of the present invention provide greatly enhanced flavor, juiciness and mouth-feel of their pre-method counterparts.

In view of the foregoing, it will be seen that there have been provided in this disclosure a new, useful, and non-obvious method for improving the taste of a bratwurst product; that provides such a method such that a minimal number of steps and equipment is required to implement the method; that provides such a method whereby the taste of a bratwurst product can be improved by using foodstuffs that are readily and commercially available to the consumer; that provides such a method whereby the improved bratwurst product can be stored frozen and re-heated for convenient consumption by the consumer.

What is claimed:

1. A method for enhancing a food product, such food product comprising a bratwurst sausage product, the method comprising the steps of
cooking the bratwurst sausage product,
soaking the cooked bratwurst sausage product in a liquid bath,
bringing the liquid of the liquid bath and the bratwurst sausage product contained in the liquid bath to a non-boiling simmer,
cooling the liquid of the liquid bath and the bratwurst sausage product contained in the liquid bath,
removing the bratwurst sausage product from the liquid bath, and
alternatively re-heating the bratwurst sausage product for immediate consumption or freezing the bratwurst sausage product for later consumption.

2. The method of claim 1 wherein the step of bringing the liquid of the liquid bath to a non-boiling simmer is followed by the step of simmering the liquid for a first period of time.

3. The method of claim 2 wherein the step of cooling the liquid of the liquid bath includes cooling the liquid of the liquid bath for a second period of time.

4. An improved food product made in accordance with the method of claim 3.

5. A method for enhancing a food product, such food product comprising a bratwurst sausage product, the method comprising the steps of
providing a grill unit having a cooking grid that is suspended above a heat source,
cooking the bratwurst sausage product on the cooking grid,
providing a cooking pot,
placing the cooked bratwurst sausage product within the cooking pot in a generally closely-packed and layered configuration,
adding a first liquid product to the cooking pot,
adding a second liquid product to the cooking pot to fully submerge the cooked bratwurst sausage product within the cooking pot and below the combined liquid level,
soaking the cooked bratwurst sausage product in the liquid bath created by the combined first and second liquid products,
placing the pot, liquid bath and the bratwurst sausage product over a relatively low heat source,
bringing the liquid of the liquid bath and the bratwurst sausage product contained in the liquid bath to a non-boiling simmer such that a minimum amount of liquid is released as vapor from the pot,
cooling the liquid of the liquid bath and the bratwurst sausage product contained in the liquid bath,
removing the bratwurst sausage product from the liquid bath, and
alternatively re-heating the bratwurst sausage product for consumption or freezing the bratwurst sausage product for later consumption.

6. The method of claim 5 wherein the step of providing a grill unit comprises the further steps of selecting a grill unit from a group consisting of a charcoal grill or a gas-fueled grill and providing a grill unit having a cooking grid comprising a plurality of longitudinally-extending and equally-spaced, parallel rods upon which the bratwurst sausage product may be placed.

7. The method of claim 6 wherein the step of cooking the bratwurst sausage product comprises the further steps of sequentially placing the bratwurst sausage product in a first cooking position for a first period of time, placing the bratwurst sausage product in a second cooking position for a second period of time, placing the bratwurst sausage product in a third cooking position for a third period of time, and placing the bratwurst sausage product in a fourth cooking position for a fourth period of time.

8. The method of claim 7 wherein the bratwurst sausage product has a generally C-shaped axis and wherein the second cooking position is axially 180° from the first cooking position, the third cooking position is 90° from the second cooking position, and the fourth cooking position is 180° from the third cooking position.

9. The method of claim 8 wherein the first, second, third and fourth cooking times may each range between 8 and 10 minutes.

10. The method of claim 5 wherein the step of adding a first liquid product comprises adding a beer product and wherein the step of adding a second liquid product comprises adding a bottled water product.

11. The method of claim 10 wherein the beer product and the bottled water product adding steps comprise adding the beer product and the bottled water product in a ratio of three-to-one.

12. The method of claim 5 wherein the step of bringing the liquid bath to a non-boiling simmer includes the step of simmering the liquid bath for several hours.

13. The method of claim 5 wherein the step of cooling the liquid bath and the bratwurst sausage products includes the step of cooling the liquid bath and the bratwurst sausage products for twelve hours.

14. An improved food product made in accordance with the method of claim 5.
